(19) United States
(12) Patent Application Publication
(10) Pub. No.: US 2026/0358933 A1
(43) Pub. Date: Nov. 12, 2026

(54) ELECTRONIC APPARATUS FOR PROVIDING A USER INTERFACE AND CONTROL METHOD THEREFOR

(71) Applicant: SAMSUNG ELECTRONICS CO., LTD., Suwon-si (KR)

(72) Inventors: Yoonhee CHOI, Suwon-si (KR); Donghyun KIM, Suwon-si (KR); Jinhee PYUN, Suwon-si (KR)

(73) Assignee: SAMSUNG ELECTRONICS CO., LTD., Suwon-si (KR)

(21) Appl. No.: 19/718,624

(22) Filed: Jun. 24, 2026

Related U.S. Application Data
(63) Continuation of application No. PCT/KR2024/020105, filed on Dec. 9, 2024.

(30) Foreign Application Priority Data
Jan. 3, 2024 (KR) 10-2024-0000947
Apr. 9, 2024 (KR) 10-2024-0048230

(51) Int. Cl. G06F 3/0482; F25D 23/06; G06F 40/186; G06F 40/40; G06T 11/10; G06V 20/68

(52) U.S. Cl. CPC G06F 3/0482; F25D 23/062; G06F 40/186; G06T 11/10; F25D 2700/06; G06F 40/40; G06T 2200/24; G06V 20/68

(57) ABSTRACT

An electronic apparatus including: a display; a memory storing at least one instruction; and at least one processor configured to execute the at least one instruction, wherein, the at least one instruction, when executed by the at least one processor individually or collectively, cause the electronic apparatus to: obtain a text prompt based on information about an article stored in a repository; obtain a personalized user interface (UI) image based on the text prompt, UI layout information, and color information related to the electronic apparatus, and provide the personalized UI image through the display.

### CROSS REFERENCE TO RELATED APPLICATIONS

This application is a continuation of International Application No. PCT/KR2024/020105, filed on Dec. 9, 2024, which is based on and claims priority to Korean Patent Application No. 10-2024-0000947, filed on Jan. 3, 2024, and Korean patent Application No. 10-2024-0048230, filed on Apr. 9, 2024, in the Korean Ministry of Intellectual Property, the disclosures of which are incorporated by reference herein in their entireties.

### BACKGROUND

### 1. Field

The present disclosure relates to an electronic apparatus and a control method therefor, and more particularly, to an electronic apparatus for providing a user interface (UI) screen and a control method therefor.

### 2. Description of Related Art

Various types of electronic apparatuses have been developed and distributed due to the development of electronic technology. In particular, recently, various types of electronic apparatuses have been developed in which a display is included in a home appliance such as a refrigerator.

In general, a home appliance including a display may provide various UI screens such as a wallpaper screen. However, inconvenience may occur in that a user is required to perform many manipulation inputs to apply a preference of the user to a user interface (UI) screen.

### SUMMARY

According to an aspect of the disclosure, there is provided an electronic apparatus including a display; memory storing at least one instruction; and at least one processor operatively connected to the display and the memory, wherein, the at least one instruction, when executed by the at least one processor individually or collectively, causes the electronic apparatus to: obtain a text prompt based on information about an article stored in a repository; obtain a personalized user interface (UI) image based on the text prompt, UI layout information, and color information related to the electronic apparatus; and display, through the display, the personalized UI image.

According to another aspect of the disclosure, there is provided a control method for an electronic apparatus, the method including obtaining a text prompt based on information about an article stored in a repository; obtaining a personalized user interface (UI) image based on the text prompt, UI layout information, and color information related to the electronic apparatus; and displaying the personalized UI image.

According to another aspect of the disclosure, there is provided a non-transitory computer-readable medium storing computer instructions that, when executed by at least one processor of an electronic apparatus, cause the electronic apparatus to perform operations comprising: obtaining a text prompt based on information about an article stored in a repository; obtaining a personalized user interface (UI) image based on the text prompt, UI layout information, and color information related to the electronic apparatus; and displaying the personalized UI image.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an implementation example of an electronic apparatus according to one or more embodiments;

FIG. 2A is a block diagram illustrating a configuration of the electronic apparatus according to an embodiment;

FIG. 2B is a block diagram illustrating a detailed configuration of the electronic apparatus according to one or more embodiments;

FIG. 3 is a flowchart illustrating a control method for an electronic apparatus according to one or more embodiments;

FIG. 4 is a flowchart illustrating a control method for an electronic apparatus according to one or more embodiments;

FIG. 5 is a flowchart illustrating a control method for an electronic apparatus according to one or more embodiments;

FIG. 6 is a diagram illustrating a method for acquiring a background image according to one or more embodiments;

FIG. 7 is a diagram illustrating a method for acquiring a background image according to one or more embodiments;

FIG. 8 is a diagram illustrating a method for acquiring a background image according to one or more embodiments;

FIG. 9 is a diagram illustrating a method for acquiring a background image according to one or more embodiments;

FIG. 10 is a diagram illustrating a method of training a generative artificial intelligence (AI) model according to one or more embodiments;

FIG. 11 is a diagram illustrating a method of generating a background image of a generative AI model according to one or more embodiments;

FIG. 12A is a diagram illustrating a method of providing a user interface (UI) screen according to one or more embodiments;

FIG. 12B is a diagram illustrating a method of providing a UI screen according to one or more embodiments;

FIG. 12C is a diagram illustrating a method of providing a UI screen according to one or more embodiments;

FIG. 13 is a diagram illustrating a method of providing a UI screen according to one or more embodiments;

FIG. 14A is a diagram illustrating a method of providing a UI screen according to one or more embodiments; and

FIG. 14B is a diagram illustrating a method of providing a UI screen according to one or more embodiments.

### DETAILED DESCRIPTION

Terms used in the present disclosure will be briefly described first, and the present disclosure will then be described in detail.

Terms used in embodiments of the present disclosure are selected from currently widely used general terms as far as possible while considering functions in the present disclosure. However, the terms may vary according to intentions of those skilled in the art, precedents, emergence of new technology, or the like. In addition, in a specific case, terms arbitrarily selected by an applicant may also be used. In this case, the meanings of such terms will be described in detail in corresponding descriptions of the present disclosure. Accordingly, the terms used in the present disclosure should be defined based on the meanings of the terms and the contents throughout the present disclosure, rather than based on simple names of the terms.

In the present disclosure, the expression such as “have,” “may have,” “include,” or “may include,” indicates the presence of a corresponding feature (e.g., a numerical value, a function, an operation, or a component such as a part), and does not exclude the presence of an additional feature.

In the present disclosure, expressions such as “A or B,” “at least one of A or/and B,” or “one or more of A or/and B” may include all possible combinations of items listed together. For example, “A or B,” “at least one of A and B,” or “at least one of A or B” may refer to all of (1) including only A, (2) including only B, or (3) including both A and B.

Expressions such as “first,” “second,” “firstly,” or “secondly” used in the present specification may modify various components regardless of order and/or importance, and are used only to distinguish one component from another component without limiting the corresponding components.

When it is described that a component (e.g., a first component) is “(operatively or communicatively) coupled with/to” or “connected to” another component (e.g., a second component), it should be understood that the component may be directly connected to the other component or may be connected through another component (e.g., a third component).

The expression “configured to (or set to)” used in the present disclosure may be replaced with, for example, “suitable for,” “having the capacity to,” “designed to,” “adapted to,” “made to,” or “capable of,” depending on a context. The term “configured to (or set to)” may not necessarily refer to only “specifically designed to” in terms of hardware.

In some contexts, an expression “a device configured to” may refer to a device capable of “performing” a corresponding function in combination with another device or component. For example, a phrase “a processor configured to (or set to) perform A, B, and C” may refer to a dedicated processor (e.g., an embedded processor) capable of performing the corresponding operation, or a generic-purpose processor (e.g., a central processing unit (CPU) or an application processor) capable of performing the operation by executing one or more software programs stored in a memory device.

A singular expression includes a plural expression unless the context clearly indicates otherwise. It should be understood that in the present application, terms such as “include” or “be configured” are intended to indicate the presence of a feature, a number, a step, an operation, a component, a part, or a combination thereof described in the specification, and do not preclude the presence or addition possibility of one or more other features, numbers, steps, operations, components, parts, or combinations thereof.

In an embodiment, a “module” or a “unit” may perform at least one function or operation, and may be implemented as hardware or software, or implemented as a combination of hardware and software. In addition, a plurality of “modules” or a plurality of “units” may be integrated into at least one module and implemented by at least one processor, except for a “module” or a “unit” required to be implemented as specific hardware.

Meanwhile, various elements and regions in drawings are schematically illustrated. Therefore, the spirit of the present disclosure is not limited by relative sizes or intervals illustrated in the accompanying drawings.

Hereinafter, an embodiment of the present disclosure will be described in more detail with reference to the accompanying drawings.

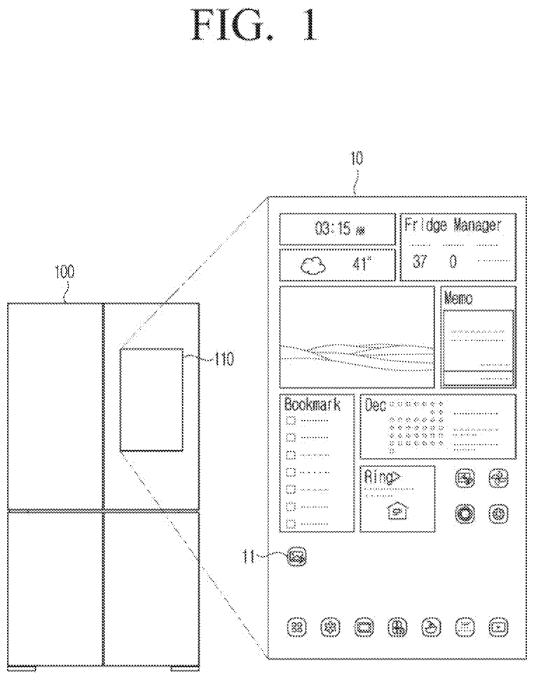

FIG. 1 is a diagram illustrating an implementation example of an electronic apparatus according to one or more embodiments.

Referring to FIG. 1, an electronic apparatus 100 may be implemented as a refrigerator, and is not limited thereto. For example, the electronic apparatus 100 may be implemented as various devices for storing an article (for example, food) in a predetermined space, such as a refrigerator, a kimchi refrigerator, a wine refrigerator, an oven, a microwave oven, a washing machine, or a dryer.

According to an example, the electronic apparatus 100 may be implemented as an internet of thing (IoT) device for supporting a wireless fidelity (Wi-Fi) module.

The electronic apparatus 100 may download and install various applications from a server providing applications. An application is software directly used by a user on an operating system (OS), and may be provided in a form of an icon interface on a user interface (UI) screen 10 of the electronic apparatus 100. According to an example, the application may perform a related operation by communicating with a related server. For example, the server may be implemented as a cloud server, and is not limited thereto.

According to an example, an application provided on the UI screen 10 of the electronic apparatus 100 may include an application 11 for generating an image. The image generation application 11 may generate various images including wallpaper provided through a display 110 of the electronic apparatus 100.

According to an example, a user may log in to a server related to the image generation application 11 through a user account. In this case, the electronic apparatus 100 may communicate with the server based on the logged-in user account.

According to an example, the electronic apparatus 100 may provide a UI screen, for example, a wallpaper image, based on the user account logged in through the image generation application 11.

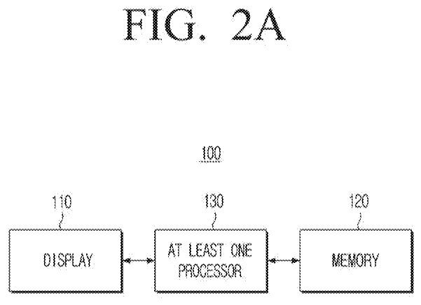

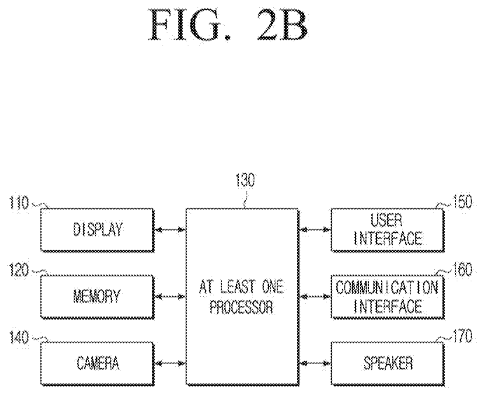

FIG. 2A is a block diagram illustrating a configuration of the electronic apparatus according to an embodiment.

Referring to FIG. 2A, the electronic apparatus 100 may include the display 110, memory 120, and at least one processor 130 (hereafter also referred to as “the processor”).

The electronic apparatus 100 may be implemented as a device for storing an article in a repository. According to an example, the electronic apparatus 100 may be implemented as a device for storing food in a repository, such as a refrigerator, a kimchi refrigerator, a wine refrigerator, an oven, or a microwave oven, and is not limited thereto. However, the repository may not be comprised in the electronic apparatus 100 and may instead be a storage provided in an external device.

The display 110 may be implemented as a display including a self-emissive element. For example, the display 110 may be implemented as various types of displays such as an organic light emitting diode (OLED) display, light emitting diodes (LED), a micro LED, a mini LED, a plasma display panel (PDP), a quantum dot (QD) display, or quantum dot light-emitting diodes (QLED). A driving circuit, a backlight unit, or the like, which may be implemented in forms such as an amorphous silicon (a-Si) thin film transistor (TFT), a low temperature poly silicon (LTPS) TFT, or an organic TFT (OTFT), may also be included in the display 110. According to an example, a touch sensor having a form of a touch film, a touch sheet, a touch pad, or the like and sensing a touch operation may be disposed on a front surface of the display 110 and implemented to sense various types of touch inputs. For example, the display 110 may sense various types of touch inputs, such as a touch input by a user hand, a touch input by an input device such as a stylus pen, or a touch input by a specific electrostatic material. Here, the input device may be implemented as a pen-type input device that may be referred to by various terms such as an electronic pen, a stylus pen, or an S-pen. According to an example, the display 110 may be implemented as a flat display, a curved display, a folding and/or rolling flexible display, or the like.

The memory 120 may store data required for various embodiments. The memory 120 may be implemented as a memory embedded in the electronic apparatus 100 according to a data storage purpose, or may also be implemented as a memory detachable from the electronic apparatus 100. For example, data for driving the electronic apparatus 100 may be stored in the memory embedded in the electronic apparatus 100, and data for an extension function of the electronic apparatus 100 may be stored in the memory detachable from the electronic apparatus 100. Meanwhile, the memory embedded in the electronic apparatus 100 may be implemented as at least one of a volatile memory (e.g., a dynamic random access memory (DRAM), a static random access memory (SRAM), or a synchronous dynamic random access memory (SDRAM)), or a non-volatile memory (e.g., a one-time programmable read only memory (OTPROM), a programmable read only memory (PROM), an erasable and programmable read only memory (EPROM), an electrically erasable and programmable read only memory (EEPROM), a mask ROM, a flash ROM, a flash memory (e.g., NAND flash or NOR flash), a hard drive, or a solid state drive (SSD). In addition, the memory detachable from the electronic apparatus 100 may be implemented in a form such as a memory card (for example, a compact flash (CF), a secure digital (SD), a micro secure digital (Micro-SD), a mini secure digital (Mini-SD), an extreme digital (xD), or a multi-media card (MMC)), or an external memory connectable to a universal serial bus (USB) port (for example, a USB memory).

According to an example, the memory 120 may store a computer program including at least one instruction for controlling the electronic apparatus 100.

According to another example, the memory 120 may store data required for various embodiments, such as a predetermined rule used for generating a text prompt, an image acquired through a camera 140, or information about an article (for example, food) stored in a repository.

In the above-described embodiment, various data is described as being stored in the memory 120 outside the processor 130, and at least some of the above-described data may also be stored in the memory inside the processor 130 according to an implementation example of at least one of the electronic apparatus 100 or the processor 130.

At least one processor 130 may control an overall operation of the electronic apparatus 100. Specifically, at least one processor 130 may be connected to each component of the electronic apparatus 100 and control the overall operation of the electronic apparatus 100. For example, at least one processor 130 may be operatively connected to the memory 120 and control the overall operation of the electronic apparatus 100. At least one processor 130 may include one or more processors.

At least one processor 130 may perform operations of the electronic apparatus 100 according to various embodiments by executing at least one instruction stored in the memory 120.

According to an example, a function related to artificial intelligence according to the present disclosure may be operated through the processor and the memory of the electronic apparatus.

At least one processor 130 may include one or more processors. Here, one or more processors may include at least one of a central processing unit (CPU), a graphic processing unit (GPU), or a neural processing unit (NPU), and is not limited to the above-described examples of the processor.

The CPU is a generic-purpose processor capable of performing not only general operations but also artificial intelligence operations, and may efficiently execute a complex program by using a multi-layer cache structure. The CPU may be advantageous for a serial processing method allowing organic connection between a previous calculation result and a next calculation result through sequential calculation. The generic-purpose processor is not limited to the above-described example except for a case in which the processor is specified as the above-described CPU.

The GPU is a processor for a large amount of operations such as floating-point operations used for graphics processing, and may integrate a large number of cores and perform large-scale operations in parallel. In particular, the GPU may be advantageous for a parallel processing method such as a convolution operation compared to the CPU. In addition, the GPU may be used as a co-processor for supplementing a function of the CPU. The processor for a large amount of operations is not limited to the above-described example except for a case in which the processor is specified as the above-described GPU.

The NPU is a processor specialized for artificial intelligence operations using an artificial neural network, and may implement each layer included in the artificial neural network as hardware (for example, silicon). Here, the NPU is specialized and designed according to required specifications of a company, and has a lower degree of freedom compared to the CPU or the GPU, while the NPU may efficiently process artificial intelligence operations required by the company. Meanwhile, as a processor specialized for artificial intelligence operations, the NPU may be implemented in various forms such as a tensor processing unit (TPU), an intelligence processing unit (IPU), or a vision processing unit (VPU). The artificial intelligence processor is not limited to the above-described example except for a case in which the processor is specified as the above-described NPU.

In addition, at least one processor 130 may be implemented as a system on chip (SoC). Here, the SoC may further include a network interface such as the memory 120 and a bus for data communication between the processor 130 and the memory 120, in addition to at least one processor 130.

When a plurality of processors is included in the system on chip (SoC) included in the electronic apparatus 100, the electronic apparatus 100 may perform operations related to artificial intelligence by using some processors among the plurality of processors (for example, operations related to learning or inference of an artificial intelligence model (or a neural network model)). For example, the electronic apparatus may perform operations related to artificial intelligence by using at least one of a GPU, an NPU, a VPU, a TPU, or a hardware accelerator specialized for artificial intelligence operations such as convolution operations, or matrix multiplication operations among the plurality of processors. However, this embodiment is merely one of one or more embodiments, and operations related to artificial intelligence may be processed using a generic-purpose processor such as a CPU.

In addition, the electronic apparatus 100 may perform operations for functions related to artificial intelligence by using a multi-core (for example, dual-core or quad-core) included in one processor. In particular, the electronic apparatus may perform artificial intelligence operations such as convolution operations or matrix multiplication operations in parallel by using the multi-core included in the processor.

At least one processor 130 may control input data to be processed according to a predefined operation rule or an artificial intelligence model stored in the memory 120. The predefined operation rule or the artificial intelligence model may be made through learning.

Here, “being made through learning” indicates that a predefined operation rule or an artificial intelligence model having desired characteristics is made by applying a learning algorithm to a plurality of learning data. The learning may be performed in a device itself in which artificial intelligence according to the present disclosure is performed, or may be performed through a separate server/system.

The artificial intelligence model may include a plurality of neural network layers. At least one layer may have at least one weight value, and perform an operation of the layer through an operation result of a previous layer and at least one defined operation. Examples of the neural network may include a convolutional neural network (CNN), a recurrent neural network (RNN), a deep neural network (DNN), a restricted Boltzmann machine (RBM), a deep belief network (DBN), a bidirectional recurrent deep neural network (BRDNN), deep Q-networks, and a Transformer, and the neural network in the present disclosure is not limited to the above-described examples except for a specified case.

The learning algorithm is a method of training a predetermined target device (for example, a robot) by using a plurality of learning data, thereby allowing the predetermined target device itself to make a determination or a prediction. Examples of the learning algorithm may include supervised learning, unsupervised learning, semi-supervised learning, or reinforcement learning, and the learning algorithm in the present disclosure is not limited to the above-described examples except for a specified case. Hereinafter, for convenience of description, at least one processor 130 will be referred to as the processor 130.

FIG. 2B is a block diagram illustrating a detailed configuration of the electronic apparatus according to one or more embodiments.

Referring to FIG. 2B, the electronic apparatus 100 may include the display 110, the memory 120, at least one processor 130, the camera 140, a user interface 150, a communication interface 160, and a speaker 170. Detailed descriptions of configurations among configurations illustrated in FIG. 2B overlapping configurations illustrated in FIG. 2A will be omitted.

The camera 140 may be turned on according to a predetermined event and capture an image. The camera 140 may convert a captured image into an electrical signal and generate image data based on the converted signal. For example, the camera 140 may include at least one of a general (or basic) camera or an ultra-wide-angle camera. For example, the camera 140 may be provided at a position at which the camera 140 may capture an inside of a storage compartment. For example, a plurality of cameras may be provided at positions at which the cameras may capture different sides of the storage compartment.

The user interface 150 may be implemented as a device such as a button, a touch pad, a mouse, and a keyboard, or may be implemented as a touch screen or the like capable of also performing the above-described display function and manipulation input function together.

According to an example, the user interface 150 may receive a user input for selecting at least one of a category, a style, or a color tone for generating a background image.

The communication interface 160 may be implemented as various interfaces according to an implementation example of the electronic apparatus 100. For example, the communication interface 160 may communicate with an external device, an external storage medium (for example, a USB memory), an external server (for example, a web hard), or the like by using a communication method such as Bluetooth, access point (AP)-based Wi-Fi (wireless LAN network), Zigbee, wired/wireless local area network (LAN), wide area network (WAN), Ethernet, IEEE 1394, high-definition multimedia interface (HDMI), universal serial bus (USB), mobile high-definition link (MHL), Audio Engineering Society/European Broadcasting Union (AES/EBU) communication, optical communication, or coaxial communication. According to an example, the communication interface 160 may communicate with another electronic apparatus, an external server and/or a remote control device, or the like.

The speaker 170 may be a component for outputting various notification sounds, voice messages, or the like as well as various audio data. The processor 130 may control the speaker 170 to output feedback or various notifications in an audio form according to various embodiments of the present disclosure.

In addition, the electronic apparatus 100 may include a sensor, a microphone, or the like according to an implementation example.

The sensor may include various types of sensors such as a touch sensor, a proximity sensor, an acceleration sensor (or a gravity sensor), a geomagnetic sensor, a gyro sensor, a pressure sensor, a position sensor, a distance sensor, or an illuminance sensor.

The microphone may be a component for receiving a user voice or other sounds and converting the user voice or other sounds into audio data. However, according to another embodiment, the electronic apparatus 100 may receive a user voice input through an external device via the communication interface 160. For example, the microphone may receive a user voice including various information required for generating a personalized UI image.

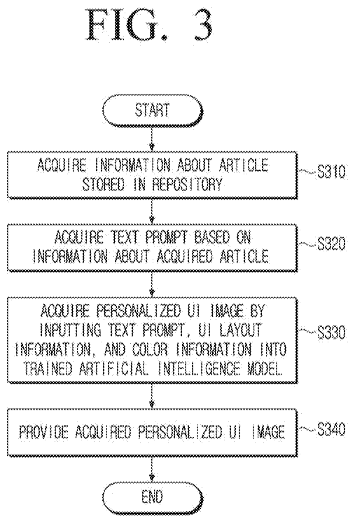

FIG. 3 is a flowchart illustrating a control method for an electronic apparatus according to one or more embodiments.

Referring to FIG. 3, in operation 310, the electronic apparatus 100 may obtain information about an article stored in a repository. According to an example, the repository may be included in the electronic apparatus 100 or may be included in an external apparatus.

According to an example, the electronic apparatus 100 may obtain information about an article stored in the repository by analyzing an image captured through the camera 140. For example, the electronic apparatus 100 may extract a feature from a captured image, identify an object based on the extracted feature, classify the identified object, and obtain information about an article stored in the repository. For example, the electronic apparatus 100 may obtain information about an article stored in the repository by inputting the captured image into an artificial intelligence (AI) model trained to classify an object.

According to an example, the electronic apparatus 100 may obtain information about a stored article based on information input by a user. For example, the user may input food information stored in the repository, expiration date information, or the like through a UI screen.

In addition, the electronic apparatus 100 may obtain information about an article stored in the repository by using various conventional refrigerator stock-in/out recognition technologies.

In operation 320, the electronic apparatus 100 may obtain a text prompt based on information about the obtained article.

A text prompt (hereinafter, a prompt) may be a text input instructing an artificial intelligence (AI) model to perform a desired task. According to an example, the prompt may have a text form instructing a UI image based on the obtained article information. According to an example, the electronic apparatus 100 may obtain a prompt for generating a UI image based on a predetermined rule. The predetermined rule may be based on at least one of a specific keyword associated with the article, a form of sentence structure of text information about the article, or a predefined template for generating the text prompt related to the article. Rule-based prompt generation may be a method of generating a prompt by using predefined rules and patterns.

In operation 330, the electronic apparatus 100 may obtain a personalized UI image (or a customized UI image) based on a text prompt, UI layout information, and color information According to an example, the electronic apparatus 100 may obtain a personalized UI image based on a text prompt, UI layout information, color information, and context information into a trained model. For example, the context information may include at least one of user context information or context information of the electronic apparatus 100.

According to an example, the electronic apparatus 100 may obtain a personalized UI image by inputting a text prompt, UI layout information, and color information into a trained artificial intelligence model.

According to an example, the electronic apparatus 100 may obtain a personalized UI image by inputting a text prompt, UI layout information, color information, and context information into a trained model

According to an example, the electronic apparatus 100, based on information on the article corresponding to a predetermined pattern, may identify a predetermined template corresponding to the predetermined pattern, an obtain the text prompt based on the predetermined template.

A UI layout may refer to a manner of disposing and structuring design elements of a user interface. According to an example, the UI layout information may include information about a structure of a UI screen and positions, sizes, intervals, or the like of UI elements. According to an example, the UI layout information may include UI asset information. The UI asset information may refer to resources used to design and build a user interface. For example, the UI asset may include UI component elements such as a font, a button, an icon, or a tooltip.

According to an example, the electronic apparatus 100 may provide a plurality of UI layout information through a UI screen and identify UI layout information selected by a user.

According to an example, the electronic apparatus 100 may identify UI layout information based on a user selection, user preference information and/or a user usage history. For example, the user preference information may include visual preference indicating what a user prefers in a visual aspect. For example, the visual preference may include personal tastes for visual content such as a design style, a color, a layout, an image style, a font style, or a font size.

The color information may include at least one of color information selected by a user or color information of at least one component forming an exterior of the electronic apparatus. of the electronic apparatus 100. According to an example, the color information may include color palette information. A color palette indicates a set of colors. For example, the color palette may include color information such as a basic color, an auxiliary color, or a contrast color.

The context information may include various information such as user device information, time information, environment information, location information, social information, or physiological state information. For example, the device information may include information about a device used by a user, a device type, a screen size, and an operating system. For example, the time information may include time-related information such as a current time, a day of the week, or a season. For example, the environment information may include, as information about a surrounding environment, weather information, temperature information, or illuminance information. For example, the social information may include social network-related information such as social media activity of a user, a friend list, or contacts. For example, the physiological state information may include physiological information such as health-related data or heart rate, a sleep pattern, or activity amount obtained through a wearable device.

The trained artificial intelligence model may be implemented as a generative AI model. The generative AI model is an artificial intelligence model for generating new content based on a given input, and may generate various types of data such as text, an image, or voice. The generative AI model may pre-train large-scale data (for example, text data), and perform fine-tuning for various tasks based thereon. The generative AI model may learn a pattern of input data and generate new data based on a deep learning architecture such as a recurrent neural network (RNN), a long short-term memory (LSTM), a gated recurrent unit (GRU), or a Transformer. For example, the generative AI model may be implemented as a stable diffusion model. However, the generative AI model is not limited thereto, and may be implemented as various AI models such as a generative adversarial network (GAN) model, style transfer models, AI content generators, transformer-based models, or genetic algorithms for layout optimization.

According to an example, when the AI model is implemented in a server, the electronic apparatus 100 may transmit a prompt, UI layout information, and color information to the server, and receive a personalized UI image from the server.

According to another example, when the AI model is implemented as an on-device model included in the electronic apparatus 100, the electronic apparatus 100 may obtain a personalized UI image by inputting a prompt, UI layout information, and color information into the AI model.

According to an example, a prompt, UI layout information, and color information may be obtained by the electronic apparatus 100. According to another example, at least one of the prompt, the UI layout information, or the color information may be obtained from an external server.

In operation 330, the electronic apparatus 100 may provide the obtained personalized UI image.

According to an example, when a plurality of personalized UI images are obtained, the electronic apparatus 100 may provide a UI screen for selecting one of the plurality of personalized UI images.

According to an example, the electronic apparatus 100 may provide a preview screen of a plurality of personalized UI images. For example, the electronic apparatus 100 may sequentially provide preview images of the plurality of personalized UI images according to a priority. For example, the electronic apparatus 100 may simultaneously provide preview images of the plurality of personalized UI images on one screen.

According to an example, the electronic apparatus 100 may automatically play a plurality of personalized UI images sequentially. For example, the electronic apparatus 100 may automatically play the plurality of personalized UI images sequentially according to a priority.

Meanwhile, for convenience of description, FIG. 3 illustrates that an order is mapped to all operations. However, an order of operations having no relation to order, operations capable of being performed in parallel, or the like is not necessarily limited to the corresponding order.

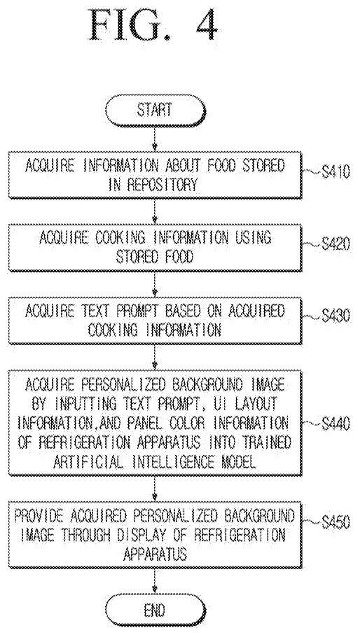

FIG. 4 is a flowchart illustrating a control method for an electronic apparatus according to one or more embodiments.

Referring to FIG. 4, in operation 410, the electronic apparatus 100 may acquire information about food stored in a repository.

According to an example, information about food stored in the repository may include at least one of type information of food stored in the repository, information about storage time points of food stored in the repository, or expiration date information of food stored in the repository.

In operation 420, the electronic apparatus 100 may acquire cooking information using stored food based on information about food stored in the repository.

According to an example, the electronic apparatus 100 may identify a cookable dish using food having an expiration date within a threshold period based on expiration date information of each of food stored in the repository. For example, the electronic apparatus 100 may identify a plurality of cookable dishes using food having an expiration date within a threshold period.

According to an example, the electronic apparatus 100 may calculate a score for each of a plurality of cookable dishes using food having an expiration date within a threshold period, and identify a priority of the plurality of dishes based on the calculated score.

For example, with respect to a first dish among a plurality of cookable dishes, the electronic apparatus 100 may calculate a first score corresponding to the first dish based on the number of total food required for the first dish, availability in the repository of food among the total food required for the first cookable dish (e.g. the number of food available in the repository among the total food required), and the number of food having an expiration date within a threshold period among food stored in the repository. In addition, with respect to a second dish among the plurality of cookable dishes, the electronic apparatus 100 may calculate a second score corresponding to the second dish based on the number of total food required for the second dish, availability in repository of food among the total food required for the second cookable dish (e.g. the number of food available in the repository among the total food required), and the number of food having an expiration date within a threshold period among food stored in the repository.

In operation 430, the electronic apparatus 100 may acquire a prompt based on the acquired cooking information.

According to an example, the electronic apparatus 100 may compare the first score corresponding to the first dish and the second score corresponding to the second dish, and acquire a prompt for a dish corresponding to a higher score.

According to an example, the electronic apparatus 100 may acquire a prompt for at least one dish having a predetermined score or more. For example, when both the first score and the second score are the predetermined score or more, the electronic apparatus 100 may acquire a prompt for each of the first dish and the second dish.

According to an example, when prompts for the first dish and the second dish are acquired, the electronic apparatus 100 may identify a priority of the first dish and the second dish based on the first score corresponding to the first dish and the second score corresponding to the second dish, and determine a display order of personalized background images acquired based on the prompts based on the identified priority.

According to an example, the electronic apparatus 100 may acquire a prompt for at least one of the first dish or the second dish based on the predetermined number of dishes for prompt acquisition. For example, the predetermined number of dishes may be set at the time of manufacture, or may be set or changed by a user. For example, when the predetermined number of dishes for prompt generation is one, the electronic apparatus 100 may acquire only a prompt for a dish having a higher score among the first dish and the second dish. For example, when the predetermined number of dishes for prompt generation is two, the electronic apparatus 100 may acquire a prompt for each of the first dish and the second dish. According to an example, the predetermined number of dishes for prompt acquisition may be automatically updated based on a user usage history. For example, although the predetermined number is two and the electronic apparatus 100 thus generates all prompts for each of the first dish and the second dish and generates background images, the predetermined number may be updated to one when the user prefers only a background image based on a dish having the highest score.

According to an example, the number of dishes for prompt acquisition may be determined based on a score of each of a plurality of dishes. For example, when a score difference between the first dish and the second dish is equal to or greater than a threshold value, the electronic apparatus 100 may acquire only a prompt corresponding to the first dish. For example, when a score difference between the first dish and the second dish is less than the threshold value, the electronic apparatus 100 may acquire a prompt corresponding to each of the first dish and the second dish. The threshold value may be set at the time of manufacture, or may be set or changed by a user. Alternatively, the threshold value may be automatically updated based on a user usage history. For example, although a score difference between the first dish and the second dish is less than the threshold value and the electronic apparatus 100 thus generates all prompts for two dishes and generates background images, the threshold value may be updated to be decreased when the user prefers only a background image based on a dish having the highest score.

In the above-described embodiment, scores for two dishes are described as being calculated. However, scores for three or more dishes may be calculated. For example, in operation 420, the electronic apparatus 100 may acquire three or more cooking information based on information about food stored in the repository. An embodiment in which a prompt is acquired when three or more cooking information is acquired may be the same as or similar to an embodiment in which a prompt is acquired when two cooking information is acquired. For example, according to an embodiment, the electronic apparatus 100 may acquire only a prompt for one dish having the highest score among three dishes, acquire only prompts for two dishes excluding a dish having the lowest score, or acquire prompts for all three dishes.

According to an embodiment, when a score for a dish is calculated, a user context and a context of the electronic apparatus 100 may be additionally reflected. For example, contexts such as a preference of the user, a current time, or current weather may be reflected as weights. For example, a weight may be reflected to a dish type according to at least one of a user preference, a current time, or current weather. For example, a higher weight may be reflected to a dish having a high preference of the user among a plurality of dishes. For example, a higher weight may be reflected to a dish suitable for a current time (for example, breakfast time) among a plurality of dishes. For example, a higher weight may be reflected to a dish suitable for current weather (for example, rainy cold weather) among a plurality of dishes.

In operation 440, the electronic apparatus 100 may acquire a personalized background image by inputting a prompt, UI layout information, and color information of a panel forming an exterior of the refrigerator into a trained artificial intelligence model.

In operation 450, the electronic apparatus 100 may provide the acquired personalized background image through the display 110 of the refrigerator.

Meanwhile, for convenience of description, FIG. 4 illustrates that an order is mapped to all operations. However, an order of operations having no relation to order, operations capable of being performed in parallel, or the like is not necessarily limited to the corresponding order.

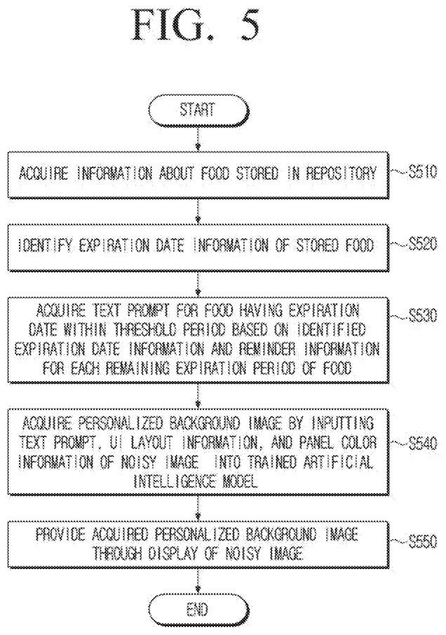

FIG. 5 is a flowchart illustrating a control method for an electronic apparatus according to one or more embodiments.

Referring to FIG. 5, in operation 510, the electronic apparatus 100 may acquire information about food stored in a repository.

In operation 520, the electronic apparatus 100 may identify expiration date information of food stored in the repository.

In operation 530, the electronic apparatus 100 may acquire a prompt for food having an expiration date within a threshold period based on the identified expiration date information and reminder information for each remaining expiration period of food.

According to an example, the reminder information for each remaining expiration period of food may include state information, type information, and style information of a reminder image for each remaining expiration period of food.

According to an example, the electronic apparatus 100 may generate a prompt based on food text corresponding to food information and expiration date information. For example, the electronic apparatus 100 may apply food text such as “tomato” and remaining expiration date information such as two days to a predetermined rule to generate a prompt related to an expiration date reminder. For example, the electronic apparatus 100 may generate a prompt having a format such as “a {Type} of {Status} {Food Text} {Style}.”

In operation 540, the electronic apparatus 100 may acquire a personalized background image by inputting a prompt, UI layout information, and panel color information of a refrigerator into a trained artificial intelligence model.

In operation 550, the electronic apparatus 100 may provide the acquired personalized background image through the display 110 of the refrigerator.

Meanwhile, for convenience of description, FIG. 5 illustrates that an order is mapped to all operations. However, an order of operations having no relation to order, operations capable of being performed in parallel, or the like is not necessarily limited to the corresponding order.

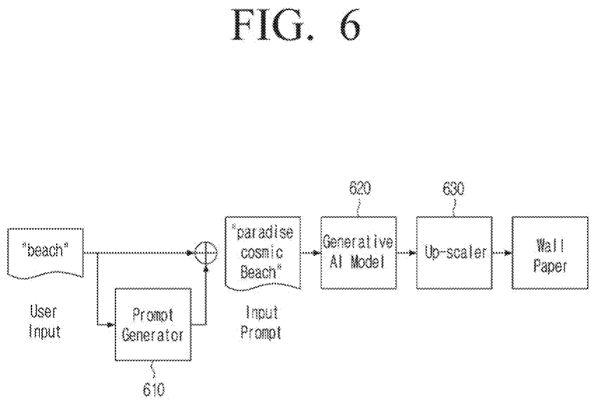

FIG. 6 is a diagram illustrating a method for acquiring a background image according to one or more embodiments.

According to an embodiment illustrated in FIG. 6, the electronic apparatus 100 may acquire a background image based on a user input.

According to an embodiment illustrated in FIG. 6, the electronic apparatus 100 may include a prompt generator 610, a generative AI model 620, and an upscaler 630. According to an example, at least one of the prompt generator 610, the generative AI model 620, or the upscaler 630 may be implemented as at least one software, at least one hardware and/or a combination thereof. For example, the prompt generator 610 may be implemented to use a predetermined rule, a predefined algorithm, or/and an AI model. For example, at least one of the prompt generator 610, the generative AI model 620, or the upscaler 630 may be included in the electronic apparatus 100, or may be distributed to at least one external device (for example, a server) according to an example.

According to an example, the electronic apparatus 100 may acquire a prompt based on a user input by using the prompt generator 610. According to an example, the prompt generator 610 may generate a prompt by using a predetermined rule and/or a predefined algorithm.

According to an example, when a user input of text “beach” is received, the electronic apparatus 100 may input the user input into the prompt generator 610. The prompt generator 610 may generate a prompt “paradise cosmic Beach” based on a predetermined rule. The predetermined rule may be based on at least one of a specific keyword associated with the article, a form of sentence structure of text information about the article, or a predefined template for generating the text prompt related to the article. For example, when input text matches a specific pattern, the prompt generator 610 may generate a prompt according to a predetermined rule. The specific pattern may be related to a specific keyword, a form of sentence structure, or the like. For example, the prompt generator 610 may generate a prompt according to a predefined template.

According to an example, the electronic apparatus 100 may acquire a background image by inputting a prompt generated by the prompt generator 610 into the generative AI model 620. For example, the generative AI model 620 may be implemented as a Stable diffusion model. In this case, the Stable diffusion model may generate a small-sized background image. Accordingly, the electronic apparatus 100 may acquire an upscaled final background image by inputting the background image generated by the generative AI model 620 into the upscaler 630. For example, a size of the background image generated by the generative AI model 620 may have a resolution of 384*672, and a size of the background image upscaled by the upscaler 630 may have a resolution of 1080*1920. However, numerical values of the resolution are merely examples and are not limited thereto. According to an example, the upscaler 630 may be implemented as an AI model for super resolution processing. However, the upscaler 630 is not limited thereto, and may also perform upscaling processing by using an algorithm such as Nearest neighbor, Bicubic, Lanczos, or Spline.

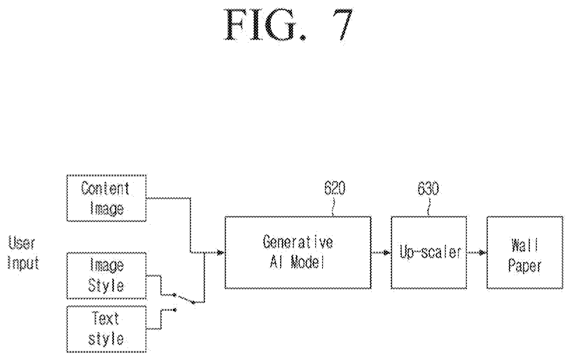

FIG. 7 is a diagram illustrating a method for acquiring a background image according to one or more embodiments.

According to an embodiment illustrated in FIG. 7, the electronic apparatus 100 may include the generative AI model 620 and the upscaler 630. According to an example, implementation examples of the generative AI model 620 and the upscaler 630 are the same as or similar to the embodiment illustrated in FIG. 6, and detailed descriptions thereof will thus be omitted.

According to an embodiment, the electronic apparatus 100 may acquire a background image by inputting information received through a user input into the generative AI model 620.

According to an example, the information received through the user input may include a content image and style information. For example, the style information may include an image style and a text style. The image style may be style information in an image form, and the text style may be style information of a text type. For example, the content image may be selected from a list including prestored images, or content stored through a user application may be selected. For example, the style information may be input as text or selected from a list. For example, the style information may include various style information such as abstract, impressionism, minimal composition, cubism, three-dimensional (3D) rendering, pastel colors, whimsical look, pop art, Renaissance, Gothic art, futuristic look, illustration, graffiti painting, oil painting, Art Nouveau, sketch, Dadaist collage, Rococo painting, hyper realism, single continuous line art sketch, or line drawing.

According to an example, when a content image and style information stored in a gallery application are selected according to a user input, the electronic apparatus 100 may acquire a background image by inputting the selected content image and the selected style information into the generative AI model 620. For example, the background image acquired through the generative AI model 620 may be an image acquired by style-converting the content image based on the style information.

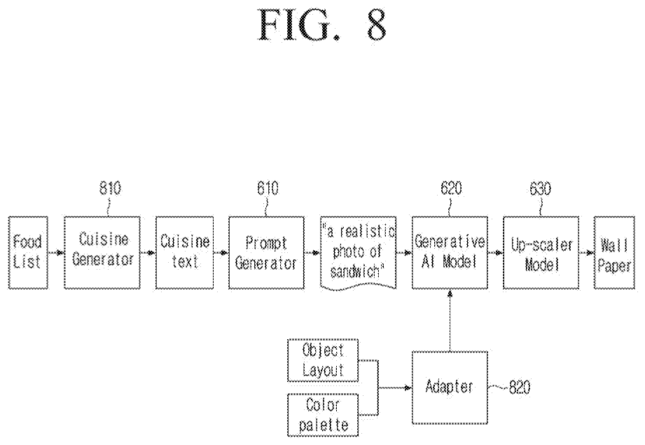

FIG. 8 is a diagram illustrating a method for acquiring a background image according to one or more embodiments.

According to an embodiment illustrated in FIG. 8, the electronic apparatus 100 may include the prompt generator 610, the generative AI model 620, the upscaler 630, a cuisine generator 810, and an adapter 820. According to an example, implementation examples of the prompt generator 610, the generative AI model 620, and the upscaler 630 are the same as or similar to the embodiment illustrated in FIG. 6, and detailed descriptions thereof will thus be omitted.

According to an example, the electronic apparatus 100 may acquire cooking information by using the cuisine generator 810. For example, the cuisine generator 810 may acquire cookable dish information based on a food list. For example, when lettuce, egg, and tomato are included in the food list, the electronic apparatus 100 may acquire cooking information “sandwich.” According to an example, the cuisine generator 810 may generate cooking information by using a predetermined rule and/or a predefined algorithm.

According to an example, the electronic apparatus 100 may input cuisine text corresponding to the cooking information acquired through the cuisine generator 810, for example, “sandwich,” into the prompt generator 610. The prompt generator 610 may generate a prompt “realistic photo of sandwich” based on a predetermined rule.

According to an example, the electronic apparatus 100 may acquire a background image by inputting a prompt generated by the prompt generator 610, object layout information, and color palette information into the generative AI model 620. For example, the electronic apparatus 100 may convert object layout information and color palette information into a data string form capable of being input into the generative AI model 620 by using the adapter 820, and input the converted object layout information and the converted color palette information into the generative AI model 620.

For example, the object layout information may include information about a structure of a UI screen and positions, sizes, intervals, or the like of UI elements. For example, the color palette information may include color information such as a basic color, an auxiliary color, or a contrast color. For example, when the electronic apparatus 100 is implemented as a refrigerator, the electronic apparatus 100 may input color palette information based on a panel color of the refrigerator into the AI model 620.

According to an example, the electronic apparatus 100 may identify a cookable dish using food having an expiration date within a threshold period, for example, within three days, based on expiration date information of each of food stored in the repository.

According to an example, the cuisine generator 810 may identify a cookable dish using food having an expiration date within three days by removing a dish including no food having an expiration date within three days among all cookable dishes, based on a list of food stored in the refrigerator.

According to an example, the cuisine generator 810 may calculate a score for each of cookable dishes using food having an expiration date within three days, and identify the predetermined number of dishes in order from the highest score. For example, the electronic apparatus 100 may calculate a score for each dish based on Equation 1 below.

score=(DI)*AI/TI [Equation 1]

TI (Total Ingredients) or TF (Total Food) may be the number of total food required for a dish, AI (Available Ingredients) or AF (Available Food) may be the number of food available in a current refrigerator among food required for the dish, and DI (Desirable Ingredients) or DF (Desirable Food) may be the number of products having an expiration date within a threshold period among food required for the dish. According to Equation 1, a dish score may be proportional to TI and AI and inversely proportional to DI.

According to an example, the prompt generator 610 may generate a prompt having a predetermined format based on a predetermined rule. For example, the prompt generator 610 may generate a prompt having a format such as “a realistic photo of {Cuisine Text}.”

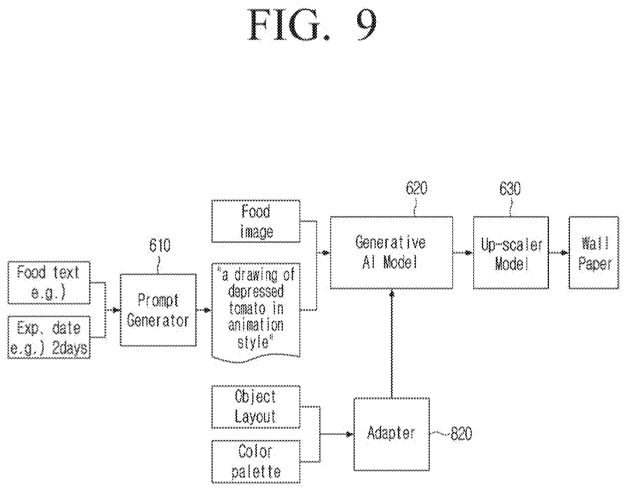

FIG. 9 is a diagram illustrating a method for acquiring a background image according to one or more embodiments.

According to an embodiment illustrated in FIG. 9, the electronic apparatus 100 may include the prompt generator 610, the generative AI model 620, the upscaler 630, and the adapter 820. According to an example, implementation examples of the prompt generator 610, the generative AI model 620, the upscaler 630, and the adapter 820 are the same as or similar to the embodiments illustrated in FIGS. 6 to 8, and detailed descriptions thereof will thus be omitted.

According to an example, the electronic apparatus 100 may input food text and expiration date information corresponding to food information into the prompt generator 610. For example, food text such as “tomato” and remaining expiration date information such as two days may be input into the prompt generator 610. The prompt generator 610 may generate a prompt related to an expiration date reminder based on a predetermined rule. For example, the prompt generator 610 may generate a prompt having a format such as “a {Type} of {Status} {Food Text} {Style}.”

According to an example, the prompt generator 610 may generate a prompt related to an expiration date reminder based on a rule as shown in Table 1 below.

TABLE 1

| Expiration Date | Status | Type | Style |
|---|---|---|---|
| <1 day | terrified | drawing | in animation |
| | | | style |
| 2 to 3 days | depressed | drawing | in animation |
| | | | style |
| 4 to 7 days | bored | drawing | in animation |
| | | | style |
| >7 days | fresh | realistic photo | |

According to an example, the electronic apparatus 100 may acquire a background image by inputting a prompt generated by the prompt generator 610, a food image, object layout information, and color palette information into the generative AI model 620. For example, the electronic apparatus 100 may convert object layout information and color palette information into a data string form capable of being input into the generative AI model 620 by using the adapter 820, and input the converted object layout information and the converted color palette information into the generative AI model 620. For example, the electronic apparatus 100 may acquire a background image by inputting a prompt generated based on Table 1, for example, “a drawing of depressed tomato in animation style,” a tomato image, object layout information, and color palette information into the generative AI model 620.

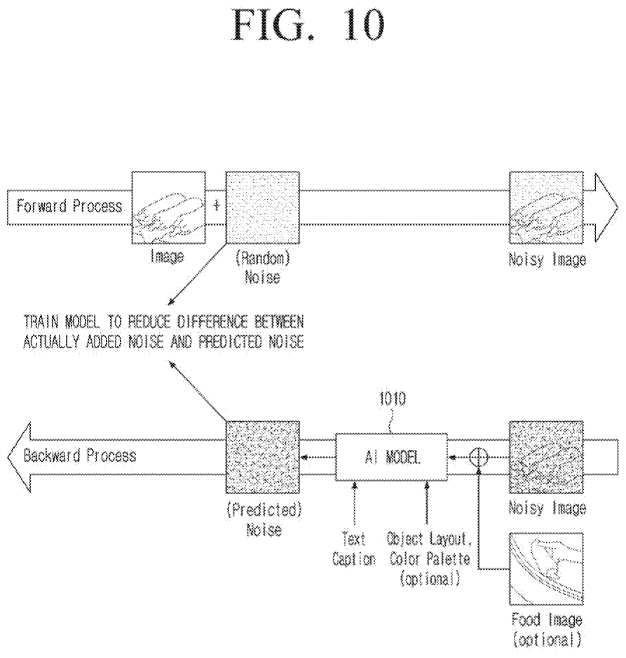

FIG. 10 is a diagram illustrating a method of training a generative AI model according to one or more embodiments.

According to an embodiment, the generative AI model may be implemented as a Diffusion Model that is a type of an image generative model, as illustrated in FIG. 10. For example, the generative AI model may be implemented as a Stable diffusion model. The Stable diffusion model is a type of deep learning model, and may be a latent diffusion model generating an artificial intelligence image from text. For example, the Stable diffusion model may first compress an image into a latent space, rather than into a high-dimensional image space.

According to an example, the Stable diffusion model may perform learning through forward diffusion and reverse diffusion.

A forward diffusion process may gradually add noise (for example, random noise) to a training image and gradually change the training image into a noisy image having no features.

A reverse diffusion process may start from a noisy image and restore an original image. According to an example, the reverse diffusion process may train an AI model 1010 to predict added noise. For example, the AI model 1010 may be trained to reduce a difference between actually added noise Eᵣₑₐₗ and predicted noise E_{pred}. For example, the AI model 1010 may use a U-Net model referred to as a noise predictor, and is not limited thereto.

According to an example, the AI model 1010 may be trained through conditioning, that is, condition assignment. The reason is that an image may be randomly generated when training is performed without conditioning. Accordingly, the AI model 1010 may be trained through text conditioning related to a training image. For example, a text caption corresponding to the training image may be input into the AI model 1010 for training. For example, the text caption may be tokenized through a text encoder in the AI model 1010, then converted into a form of an embedding vector, and used for training.

According to an example, not only a text caption corresponding to a training image, but also additional information such as object layout information, color palette information, and/or a food image may be used as conditioning, and the present disclosure is not limited thereto.

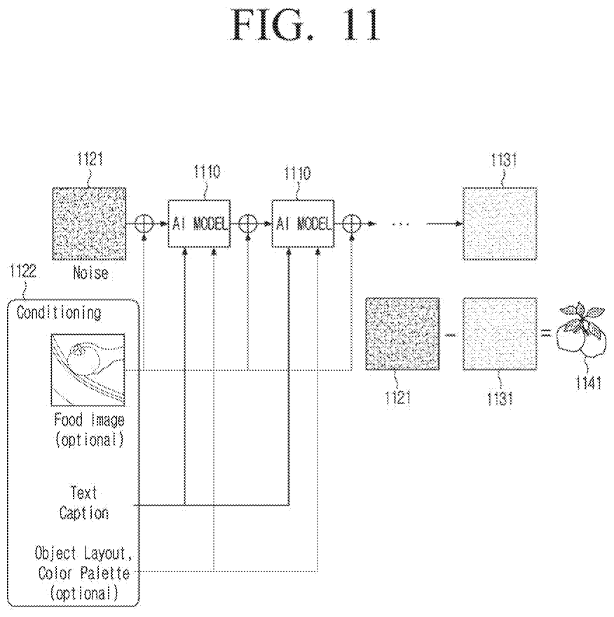

FIG. 11 is a diagram illustrating a method of generating a background image of a generative AI model according to one or more embodiments.

According to an embodiment illustrated in FIG. 11, the electronic apparatus 100 may acquire a background image 1141 by inputting a noisy image 1121 and conditioning information 1122 into a generative AI model 1110. According to an example, the conditioning information 1122 may include text caption information. According to an example, the conditioning information 1122 may selectively include at least one of a food image, object layout information, or color palette information, in addition to the text caption information.

According to an example, the electronic apparatus 100 may acquire the background image 1141 by repeatedly performing an operation of inputting the noisy image 1121 and the conditioning information 1122 into the generative AI model 1110 and inputting predicted noise output from the generative AI model 1110 into the generative AI model 1110 together with the conditioning information 1122. The generative AI model 1110 may acquire the background image 1141 based on a difference between the noisy image 1121 and final predicted noise 1131. For example, the generative AI model 1110 may acquire the background image 1141 by removing (subtracting) the final predicted noise 1131 from the noisy image 1121.

According to an example, the generative AI model 1110 may be implemented to include a text encoder, an image information generator, and an image decoder.

The text encoder may provide, to the image information generator, text embedding acquired by tokenizing an input text caption and converting the tokenized text caption into a form of an embedding vector.

When a multidimensional array including text embedding and noise is input, the image information generator may generate an information array by using a U-Net and a scheduler that gradually process or diffuse information in a latent space. According to an example, the U-Net may include a series of layers, and each layer may operate on an output of a previous layer.

The image decoder may generate the background image 1141 based on an information array output from the image information generator.

According to an example, the electronic apparatus 100 may reflect a feature corresponding to a food image among the conditioning information 1122 by concatenating the feature to an image feature in the generative AI model 1110.

According to an example, the electronic apparatus 100 may reflect a prompt generated by the prompt generator 610, for example, a text caption, by cross-attending the prompt with an image feature in the generative AI model 1110.

According to an example, the electronic apparatus 100 may reflect feature information corresponding to at least one of object layout information or color palette information acquired through the adapter 820 by adding the feature information to an image feature in the generative AI model 1110.

Methods of reflecting various other conditioning information 1122 in the generative artificial intelligence (AI) model 1110 may be the same as or similar to specific operation methods used by the Stable diffusion model.

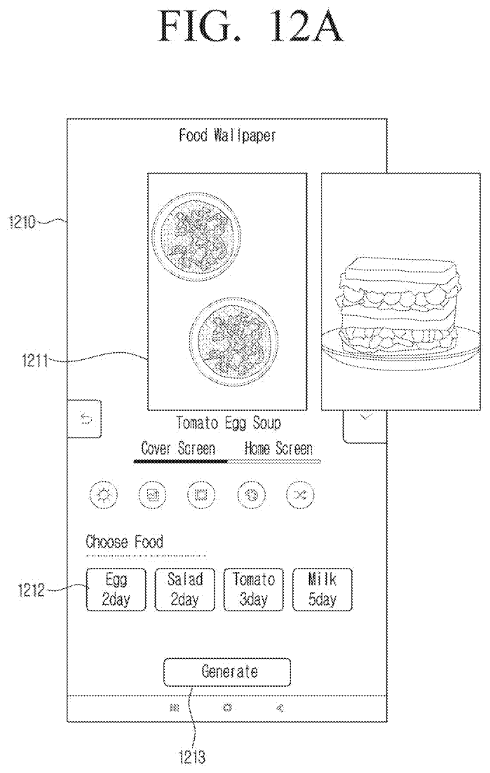

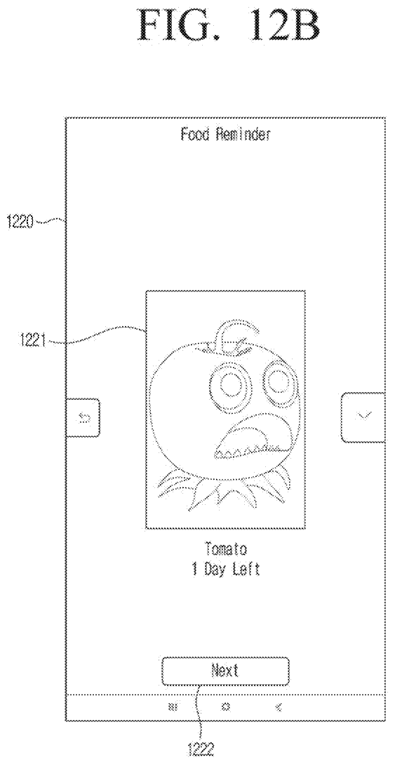

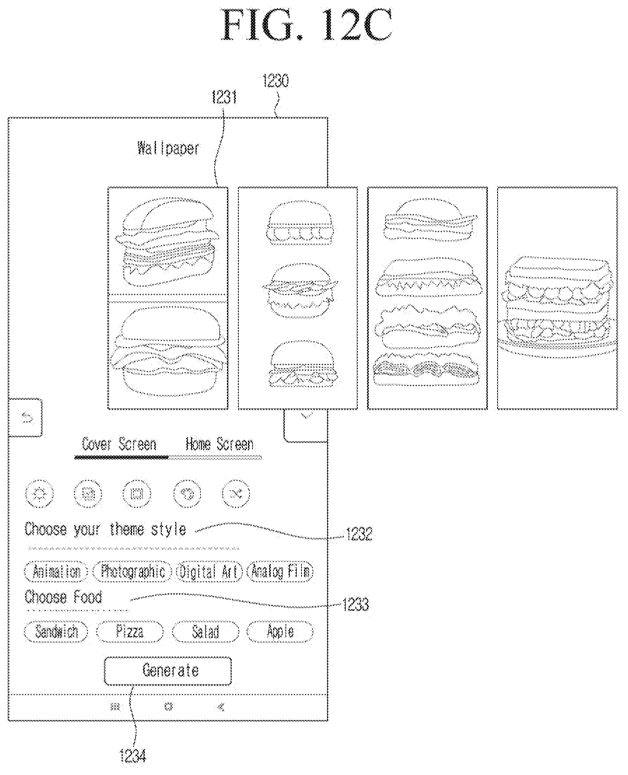

FIGS. 12A to 12B are diagrams illustrating methods of providing a UI screen according to one or more embodiments.

FIGS. 12A to 12C are diagrams illustrating examples of UI screens provided through a front display of a refrigerator when the electronic apparatus 100 is implemented as the refrigerator according to an embodiment.

Referring to FIG. 12A, a UI screen 1210 may include an image preview 1211, a food selection menu 1212, and an image generation button 1213.

According to an example, the food selection menu 1212 may include a plurality of items for selecting food information and expiration date information.

According to an example, when at least one food, for example, egg and tomato, is selected through the food selection menu 1212, a dish image using the selected foods may be provided in a region of the image preview 1211. The term “region” indicates a part of an image, and refers to at least one pixel block or a set of pixel blocks. For example, when the electronic apparatus 100 identifies tomato egg soup and tomato egg sandwich as dishes cookable by using the selected food, the electronic apparatus 100 may acquire a first dish image corresponding to the tomato egg soup and a second dish image corresponding to the tomato egg sandwich by using generative AI, and provide the first dish image and the second dish image in the region of the image preview 1211. For example, the first dish image and the second dish image may be sequentially provided or simultaneously provided on one screen.

According to an example, when a specific background image displayed in the region of the image preview 1211 is selected by using the image generation button 1213, the electronic apparatus 100 may identify the corresponding dish image as a personalized background image and provide the personalized background image.

Accordingly, a user may identify foods having imminent expiration dates and receive information about a cookable dish using the identified foods as a personalized background image.

However, although an embodiment is described with reference to FIG. 12A in which a user directly selects a desired dish image as a background image, the electronic apparatus 100 may automatically generate and provide a background image based on expiration date information of food without user intervention. For example, the electronic apparatus 100 may generate a plurality of dish images and provide the plurality of dish images as background images in an automatic slide format.

Referring to FIG. 12B, a UI screen 1220 may include an image preview 1221 and a next image view button 1222.

According to an example, the electronic apparatus 100 may generate an image of food having an imminent expiration date in a specific style, and provide a reminder image guiding that the expiration date is imminent in a region of the image preview 1221. For example, the reminder image may be a reminder image guiding that an expiration date of tomato is imminent, as illustrated in FIG. 12B. When the next image view button 1222 is selected, the electronic apparatus 100 may provide another food image having an imminent expiration date.

Referring to FIG. 12C, a UI screen 1230 may include an image preview 1231, a style selection menu 1232, a food selection menu 1233, and an image generation button 1234.

According to an example, the style selection menu 1232 may include a plurality of items for selecting style information to be used for generating a background image. For example, the style information may include style information such as Animation, Photographic, Digital Art, or Analog Film.

According to an example, the food selection menu 1233 may include a plurality of items including food information and/or cooking information. For example, the food selection menu 1233 may include a plurality of items sequentially listed from information about recently stored food based on refrigerator stock-in/out recognition.

According to an example, when at least one food or/and dish, for example, sandwich, is selected through the food selection menu 1233, a dish image generated based on selected style information may be provided in a region of the image preview 1231. For example, a plurality of sandwich images may be sequentially provided or simultaneously provided on one screen.

According to an example, when a specific background image displayed in the region of the image preview 1231 is selected by using the image generation button 1234, the electronic apparatus 100 may identify the corresponding dish image as a personalized background image and provide the personalized background image.

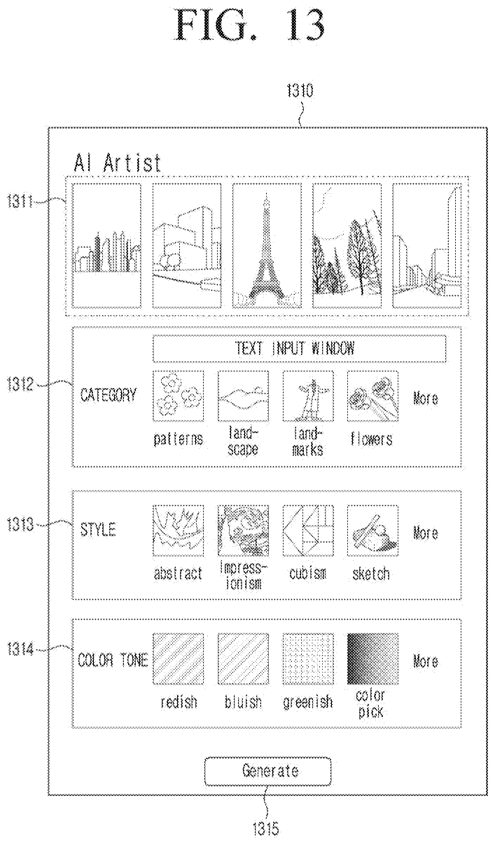

FIG. 13 is a diagram illustrating a method of providing a UI screen according to one or more embodiments.

FIG. 13 is a diagram illustrating an example of a UI screen provided through a front display of a refrigerator when the electronic apparatus 100 is implemented as the refrigerator according to an embodiment.

A UI screen 1310 according to an embodiment illustrated in FIG. 13 may include an image preview 1311, a category selection menu 1312, a style selection menu 1313, a color tone selection menu 1314, and an image generation button 1315. In addition, the UI screen may include a text input window for inputting at least one of a category, a style, or a color tone as text.

The category selection menu 1312 may provide a plurality of category information selectable by a user. For example, the plurality of category information may include at least one of patterns, landscape, landmarks, flowers, animals, food, interior, or nature, and is not limited thereto.

The style selection menu 1313 may provide a plurality of style information selectable by a user. For example, the plurality of style information may include at least one of abstract, impressionism, minimal composition, cubism, 3D rendering, pastel colors, whimsical look, pop art, Renaissance, Gothic art, futuristic look, illustration, graffiti painting, oil painting, Art Nouveau, sketch, Dadaist collage, Rococo painting, hyper realism, single continuous line art sketch, line drawing, or needle felted, and is not limited thereto.

The color tone selection menu 1314 may provide a plurality of color tone information selectable by a user. For example, the plurality of color tone information may include at least one of reddish, bluish, greenish, or color pick, and is not limited thereto. For example, the color tone information may be recommended based on a color related to the display 110 (for example, a panel color).

According to an example, the electronic apparatus 100 may generate a plurality of background images corresponding to information selected through at least one of the category selection menu 1312, the style selection menu 1313, or the color tone selection menu 1314, and provide the plurality of background images in a region of the image preview 1311.

According to an example, when a specific background image displayed in the region of the image preview 1311 is selected by using the image generation button 1315, the electronic apparatus 100 may identify the corresponding background image as a personalized background image and provide the personalized background image.

According to an embodiment, the electronic apparatus 100 may acquire a background image based on user information, preference information, and/or context information, in addition to category information, style information, and color tone information. For example, the user information may include anniversary information, calendar personal schedule information, or the like. Accordingly, the electronic apparatus 100 may generate a birthday-related image when a birthday schedule exists, and generate a year-end-related image when a year-end schedule exists.

According to an example, the user preference information may include at least one of content preference, visual preference, or digital action preference.

The content preference is a concept indicating a degree to which a user prefers a specific type of content, and may vary according to a taste and an interest of the user. For example, the content preference may include at least one of genre preference, media type preference, language and writing style preference, preference based on a depth of information, character preference, or content length preference.

The visual preference may indicate what a user prefers in a visual aspect. For example, the visual preference may include personal preferences for visual content such as a design style, a color, a layout, an image style, a font style, or a font size. According to an example, category information, style information, and color tone information may be directly selected by a user through the UI screen 1310, or category information, style information, and color tone information may be automatically selected based on user preference information.

The digital action preference may indicate a degree to which a user prefers a specific behavior or activity in a digital environment. For example, a digital action may include behaviors performed on various digital platforms, such as application usage habits, online activities (for example, online shopping or online games), digital media consumption, social media activities, or digital service usage. For example, the electronic apparatus 100 may identify the digital action preference based on information about cases such as a user frequently using a specific type of application, the user actively performing a specific type of social media activity, the user actively consuming media through a streaming service or an online video platform, or the user actively playing online games.

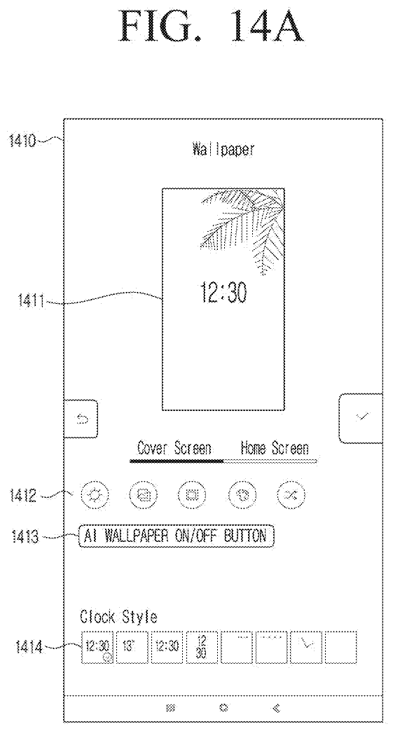

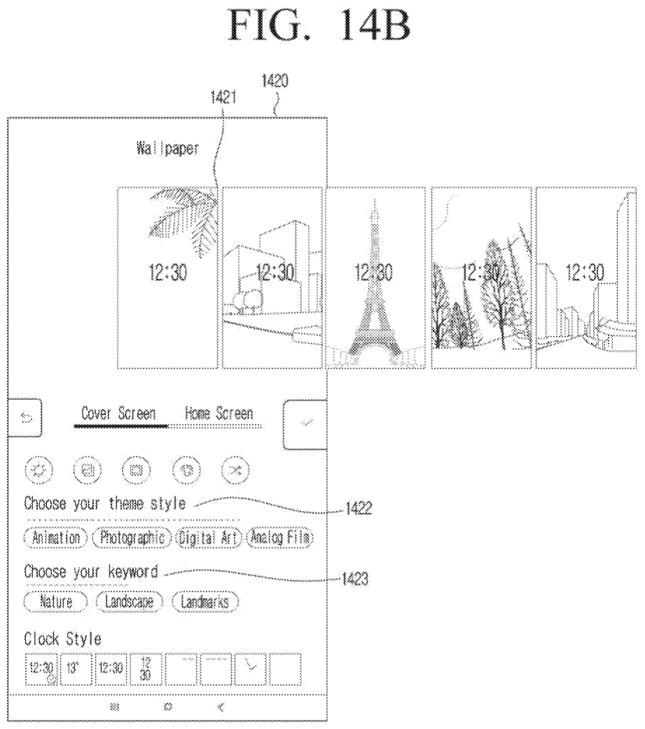

FIGS. 14A and 14B are diagrams illustrating methods of providing a UI screen according to one or more embodiments.

FIGS. 14A and 14B are diagrams illustrating examples of UI screens provided through a front display of a refrigerator when the electronic apparatus 100 is implemented as the refrigerator according to an embodiment.

A UI screen 1410 according to an embodiment illustrated in FIG. 14A may include an image preview 1411, an application menu 1412, a wallpaper on/off button 1413, and a clock style selection menu 1414. The clock style selection menu 1414 may include a plurality of clock style information.

According to an example, the wallpaper on/off button 1413 may be provided when a wallpaper application among a plurality of applications included in the application menu 1412 is selected through the UI screen 1410 illustrated in FIG. 14A.

According to an example, when the wallpaper on/off button 1413 is selected through the UI screen 1410 illustrated in FIG. 14A, a UI screen 1420 including an image preview 1421, a style selection menu 1422, a keyword selection menu 1423, and the clock style selection menu 1414 may be provided as illustrated in FIG. 14B.

According to an example, the keyword selection menu 1423 may include a plurality of keyword information used for generating a background image. For example, the plurality of keyword information may include at least one of nature, landscape, or landmarks, and is not limited thereto.

According to an example, the electronic apparatus 100 may generate a background image based on style information selected through the style selection menu 1422, keyword information selected through the keyword selection menu 1423, and context information. For example, the electronic apparatus 100 may generate a plurality of background images based on style information, keyword information, region information, and weather information.

According to the various embodiments described above, the electronic apparatus 100 may provide a personalized UI image by using a generative AI model. For example, the electronic apparatus 100 may provide a personalized background image on a display of a refrigerator by using the generative AI model.

According to an aspect of the disclosure, the electronic apparatus may comprise a display; memory storing at least one instruction; and at least one processor operatively connected to the display and the memory, wherein, the at least one instruction, when executed by the at least one processor individually or collectively, causes the electronic apparatus to: obtain a text prompt based on information about an article stored in a repository; obtain a personalized user interface (UI) image based on the text prompt, UI layout information, and color information related to the electronic apparatus; and display, through the display, the personalized UI image.

According to an example, the electronic apparatus is a refrigerator comprising the repository and a panel forming an exterior of the refrigerator, wherein the at least one instruction, when executed by the at least one processor individually or collectively, causes the electronic apparatus to: obtain the text prompt based on information about food stored in the repository; and obtain the personalized UI image based on the text prompt, the UI layout information, and color information of the panel, and wherein the information about the food stored in the repository comprises at least one of cooking information associated with the food stored in the repository, information associated with storage time points of the food stored in the repository, or information associated with expiration date of the food stored in the repository.

According to an example, wherein the electronic apparatus is a refrigerator comprising the repository, and wherein the at least one instruction, when executed by the at least one processor individually or collectively, causes the electronic apparatus to: identify food stored in the repository having an expiration date within a threshold period; identify a cookable dish based on the food stored in the repository having the expiration date within the threshold period; and obtain the text prompt based on the cookable dish.

According to an example, the at least one instruction, when executed by the at least one processor individually or collectively, causes the electronic apparatus to: obtain a first score corresponding to a first cookable dish based on a number of total food required for the first cookable dish, availability in the repository of food among the total food required for the first cookable dish, and a number of the food stored in the repository having the expiration date within the threshold period; obtain a second score corresponding to a second cookable dish based on a number of total food required for the second cookable dish, availability in the repository of food among the total food required for the second cookable dish, and a number of food stored in the repository having the expiration date within the threshold period; and obtain the text prompt based on a dish corresponding to a higher score among the first score and the second score.

According to an example, the electronic apparatus is a refrigerator comprising the repository, and wherein the at least one instruction, when executed by the at least one processor individually or collectively, causes the electronic apparatus to: identify food stored in the repository having an expiration date within a threshold period; and obtain the text prompt for the food having the expiration date within the threshold period based on the expiration date of the food and reminder information for each remaining expiration period of food, and wherein the reminder information for each remaining expiration period of food comprises at least one of state information, type information, or style information for a reminder image.

According to an example, the electronic apparatus is a refrigerator comprising the repository, and wherein the at least one instruction, when executed by the at least one processor individually or collectively, causes the electronic apparatus to: identify a priority of food stored in the repository based on time information associated with the food stored in the repository; and obtain the text prompt based on the priority.

According to an example, the at least one instruction, when executed by the at least one processor individually or collectively, causes the electronic apparatus to: obtain the personalized UI image by inputting the text prompt, the UI layout information and the color information related to the electronic apparatus into a trained model.

According to an example, the trained model is a stable diffusion model, and wherein the trained model is configured to: predict noise based on the text prompt being input, the UI layout information, the color information, and a noisy image are input; and obtain the personalized UI image based on a difference between the noisy image and the predicted noise.

According to an example, wherein the at least one instruction, when executed by the at least one processor individually or collectively, causes the electronic apparatus to: identify the UI layout information based on at least one of a selection of a user, preference information of the user or an usage history of the user, and identify the color information related to the electronic apparatus based on at least one of color information selected by the user or color information of at least one component forming an exterior of the electronic apparatus

According to an example, the at least one instruction, when executed by the at least one processor individually or collectively, causes the electronic apparatus to: based on information on the article corresponding to a predetermined pattern, identify a predetermined template corresponding to the predetermined pattern, and obtain the text prompt based on the predetermined template.

According to an example, the at least one instruction, when executed by the at least one processor individually or collectively, causes the electronic apparatus to: display, through the display, a UI screen for selecting at least one of a category, a style, or a color tone; obtain the color information related to the electronic apparatus based on the color tone selected through the UI screen; and obtain the personalized UI image based on category information and style information selected through the UI screen, the text prompt, the UI layout information, and the color information related to the electronic apparatus.

Meanwhile, the methods according to the various embodiments of the present disclosure described above may be implemented only by software upgrade or hardware upgrade of an existing electronic apparatus and/or server.

In addition, the various embodiments of the present disclosure described above may be performed through an embedded server included in the electronic apparatus, or through an external server of the electronic apparatus.

Meanwhile, according to an embodiment of the present disclosure, the various embodiments described above may be implemented as software including instructions stored in a machine-readable storage medium readable by a machine (for example, a computer). The machine is a device capable of calling the stored instructions from the storage medium and operating according to the called instructions, and may include the electronic apparatus (for example, an electronic apparatus A) according to the disclosed embodiments. When the instruction is executed by a processor, the processor may directly perform a function corresponding to the instruction or by using other components under control of the processor. The instruction may include code generated or executed by a compiler or an interpreter. The machine-readable storage medium may be provided in the form of a non-transitory storage medium. Here, “non-transitory” merely indicates that the storage medium does not include a signal and is tangible, and does not distinguish whether data is stored semi-permanently or temporarily in the storage medium.

In addition, according to an embodiment of the present disclosure, the methods according to the various embodiments described above may be included in a computer program product and provided. The computer program product may be traded between a seller and a buyer as a product. The computer program product may be distributed in the form of a machine-readable storage medium (e.g., compact disc read only memory (CD-ROM)) or online through an application store (e.g., Play Store™). In a case of online distribution, at least a portion of the computer program product may be at least temporarily stored or temporarily generated in a storage medium such as the memory of a manufacturer server, an application store server, or a relay server.

In addition, each of components (e.g., a module or a program) according to the various embodiments described above may include a single object or a plurality of objects, and some sub-components among the above-described corresponding sub-components may be omitted, or other sub-components may further be included in the various embodiments. Alternatively or additionally, some components (e.g., modules or programs) may be integrated into one object and perform the same or similar function performed by each corresponding component before integration. Operations performed by a module, a program, or another component according to the various embodiments may be executed in a sequential manner, a parallel manner, an iterative manner or a heuristic manner, or at least some operations may be executed in a different order, may be omitted, or another operation may be added.

Although the embodiments of the present disclosure are illustrated and described above, the present disclosure is not limited to the above-described specific embodiments, and various modifications may be made by those skilled in the art to which the present disclosure pertains without departing from the gist of the present disclosure as claimed in the claims, and the modified embodiments should not be individually understood apart from the spirit or scope of the present disclosure.

What is claimed is:

1. An electronic apparatus comprising:
a display;
memory storing at least one instruction; and
at least one processor operatively connected to the display and the memory,
wherein, the at least one instruction, when executed by the at least one processor individually or collectively, causes the electronic apparatus to:
obtain a text prompt based on information about an article stored in a repository;
obtain a personalized user interface (UI) image based on the text prompt, UI layout information, and color information related to the electronic apparatus; and
display, through the display, the personalized UI image.

2. The electronic apparatus of claim 1, wherein the electronic apparatus is a refrigerator comprising the repository and a panel forming an exterior of the refrigerator,
wherein the at least one instruction, when executed by the at least one processor individually or collectively, causes the electronic apparatus to:
obtain the text prompt based on information about food stored in the repository; and
obtain the personalized UI image based on the text prompt, the UI layout information, and color information of the panel, and
wherein the information about the food stored in the repository comprises at least one of cooking information associated with the food stored in the repository, information associated with storage time points of the food stored in the repository, or information associated with expiration date of the food stored in the repository.

3. The electronic apparatus of claim 1, wherein the electronic apparatus is a refrigerator comprising the repository, and
wherein the at least one instruction, when executed by the at least one processor individually or collectively, causes the electronic apparatus to:
identify food stored in the repository having an expiration date within a threshold period;
identify a cookable dish based on the food stored in the repository having the expiration date within the threshold period; and
obtain the text prompt based on the cookable dish.

4. The electronic apparatus of claim 3, wherein the at least one instruction, when executed by the at least one processor individually or collectively, causes the electronic apparatus to:
obtain a first score corresponding to a first cookable dish based on a number of total food required for the first cookable dish, availability in the repository of food among the total food required for the first cookable dish, and a number of the food stored in the repository having the expiration date within the threshold period;
obtain a second score corresponding to a second cookable dish based on a number of total food required for the second cookable dish, availability in the repository of food among the total food required for the second cookable dish, and a number of food stored in the repository having the expiration date within the threshold period; and
obtain the text prompt based on a dish corresponding to a higher score among the first score and the second score.

5. The electronic apparatus of claim 1, wherein the electronic apparatus is a refrigerator comprising the repository, and
wherein the at least one instruction, when executed by the at least one processor individually or collectively, causes the electronic apparatus to:
identify food stored in the repository having an expiration date within a threshold period; and
obtain the text prompt for the food having the expiration date within the threshold period based on the expiration date of the food and reminder information for each remaining expiration period of food, and
wherein the reminder information for each remaining expiration period of food comprises at least one of state information, type information, or style information for a reminder image.

6. The electronic apparatus of claim 1, wherein the electronic apparatus is a refrigerator comprising the repository, and
wherein the at least one instruction, when executed by the at least one processor individually or collectively, causes the electronic apparatus to:
identify a priority of food stored in the repository based on time information associated with the food stored in the repository; and
obtain the text prompt based on the priority.

7. The electronic apparatus of claim 1, wherein the at least one instruction, when executed by the at least one processor individually or collectively, causes the electronic apparatus to:
obtain the personalized UI image by inputting the text prompt, the UI layout information and the color information related to the electronic apparatus into a trained model.

8. The electronic apparatus of claim 7, wherein the trained model is a stable diffusion model, and
wherein the trained model is configured to:
predict noise based on the text prompt being input, the UI layout information, the color information, and a noisy image are input; and
obtain the personalized UI image based on a difference between the noisy image and the predicted noise.

9. The electronic apparatus of claim 1, wherein the at least one instruction, when executed by the at least one processor individually or collectively, causes the electronic apparatus to:
identify the UI layout information based on at least one of a selection of a user, preference information of the user or an usage history of the user, and
identify the color information related to the electronic apparatus based on at least one of color information selected by the user or color information of at least one component forming an exterior of the electronic apparatus.

10. The electronic apparatus of claim 1, wherein the at least one instruction, when executed by the at least one processor individually or collectively, causes the electronic apparatus to:
based on information on the article corresponding to a predetermined pattern, identify a predetermined template corresponding to the predetermined pattern, and
obtain the text prompt based on the predetermined template.

11. The electronic apparatus of claim 1, wherein the at least one instruction, when executed by the at least one processor individually or collectively, causes the electronic apparatus to:
display, through the display, a UI screen for selecting at least one of a category, a style, or a color tone;
obtain the color information related to the electronic apparatus based on the color tone selected through the UI screen; and
obtain the personalized UI image based on category information and style information selected through the UI screen, the text prompt, the UI layout information, and the color information related to the electronic apparatus.

12. A control method for an electronic apparatus, the method comprising:
obtaining a text prompt based on information about an article stored in a repository;
obtaining a personalized user interface (UI) image based on the text prompt, UI layout information, and color information related to the electronic apparatus; and
displaying the personalized UI image.

13. The method as claimed in claim 12, wherein the electronic apparatus is a refrigerator comprising the repository and a panel forming an exterior of the refrigerator,
the obtaining of the text prompt comprises:
obtaining the text prompt based on information about food stored in the repository; and
the obtaining of the personalized image comprises:
obtaining the personalized UI image based on the text prompt, the UI layout information, and color information of the panel, and
wherein the information about the food stored in the repository comprises at least one of cooking information associated with the food stored in the repository, information associated with storage time points of the food stored in the repository, or information associated with expiration date of the food stored in the repository.

14. The method of claim 13, wherein the electronic apparatus is a refrigerator comprising the repository, and
wherein obtaining the text prompt comprises:
identifying food stored in the repository having an expiration date within a threshold period;
identifying a cookable dish based on the food stored in the repository having the expiration date within the threshold period; and
obtaining the text prompt based on the cookable dish.

15. The method as claimed in claim 14, wherein the obtaining the text prompt further comprises:
obtaining a first score corresponding to a first cookable dish based on a number of total food required for the first cookable dish, availability in the repository of food among the total food required for the first cookable dish, and a number of the food stored in the repository having the expiration date within the threshold period;
obtaining a second score corresponding to a second cookable dish based on a number of total food required for the second cookable dish, availability in the repository of food among the total food required for the second cookable dish, and a number of food stored in the repository having the expiration date within the threshold period; and
obtaining the text prompt based on a dish corresponding to a higher score among the first score and the second score.

16. The method of claim 12, wherein the electronic apparatus is a refrigerator comprising the repository, and
wherein the obtaining the text prompt comprises:
identifying food stored in the repository having an expiration date within a threshold period; and
obtaining the text prompt for the food having the expiration date within the threshold period based on the expiration date of the food and reminder information for each remaining expiration period of food, and
wherein the reminder information for each remaining expiration period of food comprises at least one of state information, type information, or style information for a reminder image.

17. The method of claim 12, wherein the electronic apparatus is a refrigerator comprising the repository, and
wherein the obtaining the text prompt comprises:
identifying a priority of food stored in the repository based on time information associated with the food stored in the repository; and
obtaining the text prompt based on the priority.

18. The method of claim 12, wherein the obtaining the text prompt comprises:
based on information on the article corresponding to a predetermined pattern, identifying a predetermined template corresponding to the predetermined pattern, and
obtaining the text prompt based on the predetermined template.

19. The method of claim 12, further comprises:
display, through the display, a UI screen for selecting at least one of a category, a style, or a color tone;
obtain the color information related to the electronic apparatus based on the color tone selected through the UI screen; and
obtain the personalized UI image based on category information and style information selected through the UI screen, the text prompt, the UI layout information, and the color information related to the electronic apparatus.

20. A non-transitory computer-readable medium storing computer instructions that, when executed by at least one processor of an electronic apparatus, cause the electronic apparatus to perform operations comprising:
obtaining a text prompt based on information about an article stored in a repository;
obtaining a personalized user interface (UI) image based on the text prompt, UI layout information, and color information related to the electronic apparatus; and
displaying the personalized UI image.
